(19) United States
(12) Patent Application Publication
(10) Pub. No.: US 2026/0312407 A1
(43) Pub. Date: Oct. 8, 2026

(54) METHOD OF GENERALIZED SYNCHRONOUS OPTIMAL PULSE WIDTH MODULATION FOR RENEWABLE ENERGY STATION AND SYSTEM THEREOF

(71) Applicant: SHANDONG UNIVERSITY, Jinan (CN)

(72) Inventors: Zhenbin ZHANG, Jinan (CN); Guangze CHEN, Jinan (CN)

(21) Appl. No.: 19/445,979

(22) Filed: Jan. 12, 2026

(30) Foreign Application Priority Data
Apr. 3, 2025 (CN) 202510412436X

(51) Int. Cl. H02J 3/01; G05B 13/04; H02J 3/40; H02M 1/12

(52) U.S. Cl. CPC H02J 3/01; G05B 13/04; H02J 3/40; H02M 1/12

(57) ABSTRACT

A method of generalized synchronous optimal pulse width modulation (PWM) for a renewable energy station (RES), including: acquiring steady-state operating information of a converter cluster in RES; constructing a coordinated power quality optimization modulation equation based on steady-state operating information, and adding constraints to coordinated power quality optimization modulation equation based on fundamental volt-second characteristics and timing, to obtain optimization problem; solving the optimization problem using optimization solver to obtain optimal switching pulse sequence for converter cluster at an ideal operating point; extending a modulation range corresponding to the optimal switching pulse sequence by using a gradient descent algorithm, calculating a switching pulse sequence modulated near ideal operating point of converter cluster, distributing switching pulse sequence to each converter; and regulating output voltages of each converter to rise or fall according to time sequence positions and width values of effective control pulses in extended switching pulse sequence.

### CROSS-REFERENCE TO RELATED APPLICATIONS

The present invention claims priority to Chinese Patent Application No. 202510412436.X, filed with the China National Intellectual Property Administration on Apr. 3, 2025 and entitled “METHOD OF GENERALIZED SYNCHRONOUS OPTIMAL PULSE WIDTH MODULATION FOR RENEWABLE ENERGY STATION AND SYSTEM THEREOF”, which is incorporated herein by reference in its entirety and constitutes an integral part of the present invention for all purposes.

### TECHNICAL FIELD

The present invention relates to the technical field of grid connection and, in particular, to a method of generalized synchronous optimal pulse width modulation (PWM) for a renewable energy station (RES) and a system thereof.

### BACKGROUND

The statements in this section merely provide background information related to the present invention and do not necessarily constitute the prior art.

With the vigorous development of renewable energy, the proportion of large-scale power conversion systems, such as high-power photovoltaic power stations and offshore wind farms, in the energy sector is increasingly growing. In these systems, power converters are the core equipment for achieving efficient power conversion. To reduce losses and meet heat dissipation requirements, high-power-level power converters typically operate at low switching frequencies. However, this leads to severe harmonic distortion in the output current and voltage, causing pollution to the power grid, increasing filtering costs, and reducing the overall system performance.

High-power grid-connected converter systems, constrained by switching losses and thermal limits, generally operate at low switching frequencies in industrial products. This results in significant switching nonlinearities and severe harmonic distortion of the systems, thereby commonly requiring large passive filtering equipment, leading to large system volume and high hardware costs.

The PWM technology is a critical component of power converters. Existing PWM technologies such as carrier modulation and space vector modulation, are prone to generating low-order harmonics at low switching frequencies. While programmed modulation can manage harmonics, most existing research focuses on optimizing individual converters, neglecting the advantages brought by coordinated control of converter clusters. In practical large-scale power conversion systems, multiple power converters are often connected to the grid through a point of common coupling (PCC). The coordinated control of converter clusters is crucial to system performance. Therefore, developing a modulation technology that can fully leverage the advantages of converter clusters and reduce harmonic distortion is urgently needed.

Programmed modulation technology is an effective method to address power quality issues at low switching frequencies. However, existing solutions generally focus on optimizing the power quality of individual converters. For scenarios where internal converter systems within renewable energy stations (RESs) are distributed in clusters, the optimization degree of this method is limited, and the overall system performance improvement encounters a difficult-to-surpass bottleneck.

### SUMMARY

To overcome the deficiencies in the prior art described above, the present invention provides a method of generalized synchronous optimal PWM for a RES and a system thereof. Aimed at the problem of harmonic pollution under low switching frequencies in a high-power RES, it fully utilizes the additional control degrees of freedom brought by internal converter clusters within the RES, achieving a significant reduction in the harmonic distortion of the injected current at the PCC of the RES.

To achieve the above objective, one or more embodiments of the present invention provide the following technical solutions.

In a first aspect, the present invention provides a method of generalized synchronous optimal PWM for a RES, including:
acquiring steady-state operating information of a converter cluster in the RES;
constructing a coordinated power quality optimization modulation equation based on the steady-state operating information, and adding constraints to the coordinated power quality optimization modulation equation based on fundamental volt-second characteristics and timing, to obtain an optimization problem;
solving the optimization problem using an optimization solver to obtain an optimal switching pulse sequence for the converter cluster at an ideal operating point;
extending a modulation range corresponding to the obtained optimal switching pulse sequence by using a gradient descent algorithm, calculating a switching pulse sequence modulated near an ideal operating point of the converter cluster and distributing the switching pulse sequence to each converter in the converter cluster through a central control unit; and
receiving, by the each converter in the RES, the switching pulse sequence after the extension issued by the central control unit, confirm an effective control pulse for controlling output voltage of the each converter to rise or fall by comparing an actual output voltage with an expected output voltage of the ideal operating point of the each converter, and regulating the output voltage of the each converter to rise or fall according to a time sequence position and a width value of the effective control pulse in the switching pulse sequence after the extension, so that the converter cluster formed by the each converter in the RES works around the ideal operating point, thereby realizing harmonic optimization at a PCC of the RES.

In a further technical solution, the steady-state operating information includes modulation index, phase, and circuit parameters.

In a further technical solution, the coordinated power quality optimization modulation equation is expressed as follows:

$$Min {I}_{THD} ⇒ {\sum }_{n = 5}^{L} {i}_{n}^{2} ⇒ {\sum }_{n = 5}^{L} {( {\sum }_{j = 1}^{{N}_{j}} {i}_{n , j} )}^{2} ⇒ {\sum }_{n = 5}^{L} {( {\sum }_{j = 1}^{{N}_{j}} \frac{{K}_{j}}{n} {v}_{n , j} )}^{2} ;$$

wherein, I_{THD} represents total harmonic distortion of current; L represents inductive reactance of a line and filter; n represents a harmonic order; iₙ represents lumped harmonic current; Nⱼ represents the total number of sub-units; i_{n,j} represents n^{th} harmonic current of a j^{th} sub-unit; Kⱼ represents a converter coefficient; and v_{n,j} represents n^{th} harmonic voltage of the j^{th} sub-unit.

In a further technical solution, the optimization problem is expressed as follows:

$$Minimize EF = {\underbrace{{\sum }_{n = 5}^{L} {( {\sum }_{j = 1}^{{N}_{j}} \frac{{K}_{j} {v}_{n , j}}{n} )}^{2}}}_{PCC , curr .} + {\underbrace{{\sum }_{j = 1}^{{N}_{j}} {ℒ}_{i} {\sum }_{n = 5}^{L} {( \frac{{v}_{n , j}}{n} )}^{2}}}_{Unit , curr .} ;$$

$$Subject to \frac{2 {V}_{dc , 1}}{π} {\sum }_{i = 1}^{N} {( - 1 )}^{i + 1} cos ( {θ}_{i , 1} ) = {M}_{1 , 1} ;$$

$$\frac{2 {V}_{dc , j}}{π} {\sum }_{i = 1}^{N} {( - 1 )}^{i + 1} cos ( {θ}_{i , j} ) = {M}_{1 , j} ;$$

$$0 < {θ}_{1 , j} < {θ}_{2 , j} … < {θ}_{N , j} < \frac{π}{2} ;$$

wherein, EF represents a cost evaluation function; L represents the inductive reactance of the line and filter; n represents the harmonic order; Nⱼ represents the total number of sub-units; Kⱼ represents the converter coefficient; v_{n,j} represents the n^{th} harmonic voltage of the j^{th} sub-unit; [symbol] ᵢ represents a considered upper harmonic limit; V_{dc,1} represents a first DC bus voltage; V_{dc,j} represents a j^{th} DC bus voltage; M_{1,1} represents a desired fundamental modulation index of a first sub-unit; M_{1,j} represents a desired fundamental modulation index of the j^{th} sub-unit; θ_{i,j} represents an i^{th} switching time point of the j^{th} sub-unit; and θ_{N,j} represents an N^{th} switching time point of the j^{th} sub-unit.

In a further technical solution, preferably, the optimization solver employs a Quadratic Programming (QP) solver.

In a further technical solution, the step of extending the modulation range corresponding to the obtained optimal switching pulse sequence by using the gradient descent algorithm specifically includes: extending the modulation range corresponding to the obtained optimal switching pulse sequence using the gradient descent algorithm by changing desired fundamental modulation indexes of the sub-units.

In a further technical solution, the switching pulse sequence modulated near the ideal operating point of the converter cluster after the extension is distributed to the each converter through an information interaction manner.

In a second aspect, the present invention provides a generalized synchronous optimal pulse width modulation system for a RES, including:
a data acquisition module, configured to: acquire steady-state operating information of a converter cluster in the RES;
a problem construction module, configured to: construct a coordinated power quality optimization modulation equation based on the steady-state operating information, and add constraints to the coordinated power quality optimization modulation equation based on fundamental volt-second characteristics and timing, to obtain an optimization problem;
a problem solving module, configured to: solve the optimization problem using an optimization solver to obtain an optimal switching pulse sequence for the converter cluster at an ideal operating point;
a sequence extension module, configured to: extend a modulation range corresponding to the obtained optimal switching pulse sequence by using a gradient descent algorithm, calculate a switching pulse sequence modulated near an ideal operating point of the converter cluster, and distribute the switching pulse sequence to each converter in the converter cluster through a central control unit; and
receiving, by the each converter in the RES, the switching pulse sequence after the extension issued by the central control unit, confirm an effective control pulse for controlling output voltage of the each converter to rise or fall by comparing an actual output voltage with an expected output voltage of the ideal operating point of the each converter, and regulating the output voltage of the each converter to rise or fall according to a time sequence position and a width value of the effective control pulse in the switching pulse sequence after the extension, so that the converter cluster formed by the each converter in the RES works around the ideal operating point, thereby realizing harmonic optimization at a PCC of the RES.

In a third aspect, the present invention provides a computer-readable storage medium having stored there on a computer program, where the computer program, when executed by a processor, implements the steps of the generalized synchronous optimal pulse width modulation method for the RES according to the first aspect.

In a fourth aspect, the present invention provides a computer device, including a memory, a processor, and a computer program stored in the memory and executable on the processor, where the processor, when executing the computer program, implements the steps of the generalized synchronous optimal pulse width modulation method for the RES according to the first aspect.

The above one or more technical solutions have the following beneficial effects:

The present invention fully utilizes the additional degrees of freedom provided by converter clusters, establishes a global optimization problem for power quality by analyzing the internal pulse harmonic coupling mechanism of a RES, thereby obtaining an optimal switching pulse sequence that minimizes harmonic pollution at a PCC of the RES. The proposed method can significantly reduce the harmonic impact of RESs on the power grid.

The present invention can further enhance the grid-friendliness of RESs, reduce the volume and capacity of filters, promote cost reduction and efficiency improvement in renewable energy conversion equipment, and drive the development of related industrial chains.

Compared with conventional methods, the present invention fully utilizes the additional degrees of freedom brought by converter clusters in RESs, achieving less harmonic injection/pollution at a PCC (compared with conventional carrier modulation technology, at an extremely low switching frequency of 250 Hz, the total harmonic distortion of four converter units can be reduced by 97%). The deployment of this solution can further enhance the grid-friendliness of RESs, reduce the volume and capacity of filters, promote cost reduction and efficiency improvement in renewable energy conversion equipment, and drive the development of related industrial chains.

### BRIEF DESCRIPTION OF THE DRAWINGS

The accompanying drawings as a part of the present invention are provided to further illustrate the present invention. The exemplary embodiments of the present invention and their descriptions are intended to explain the present invention and do not constitute an undue limitation thereon.

FIG. 1A is a schematic diagram of a RES in an implementation processing of a generalized synchronous optimal pulse width modulation method according to an example of the present invention;

FIG. 1B is a schematic diagram of a global synchronous computing unit in the implementation processing of the generalized synchronous optimal PWM method according to an example of the present invention;

FIG. 2 is a schematic diagram of a simplified frequency-domain model of a power converter according to an example of the present invention.

### DETAILED DESCRIPTION

It should be noted that the following detailed description is exemplary and aims to further describe the present invention. Unless otherwise specified, all technical and scientific terms used herein have the same meanings as those generally understood by a person of ordinary skill in the art to which the present invention belongs.

It should be noted that the terms used herein are only for describing the embodiments rather than for limiting the exemplary embodiments of the present invention. As used herein, unless otherwise stated clearly in the context, a singular form is intended to include a plural form thereof. In addition, it should be understood that the terms “comprise” and/or “include” as used herein indicate the presence of features, steps, operations, devices, components and/or combinations thereof.

The examples of the present invention and the features in the examples can be combined with each other in case of no conflict.

### Example I

The present example provides a method of generalized synchronous optimal PWM for a RES, including the following steps:

S1: acquiring steady-state operating information of a converter cluster in the RES.

In the present example, through the joint deployment of a unified central control unit and local converters, each converter in the RES first uploads its respective steady-state operating information, including modulation index, phase, and circuit parameters, to the unified central control unit for collection. These data will be used to construct an optimization equation.

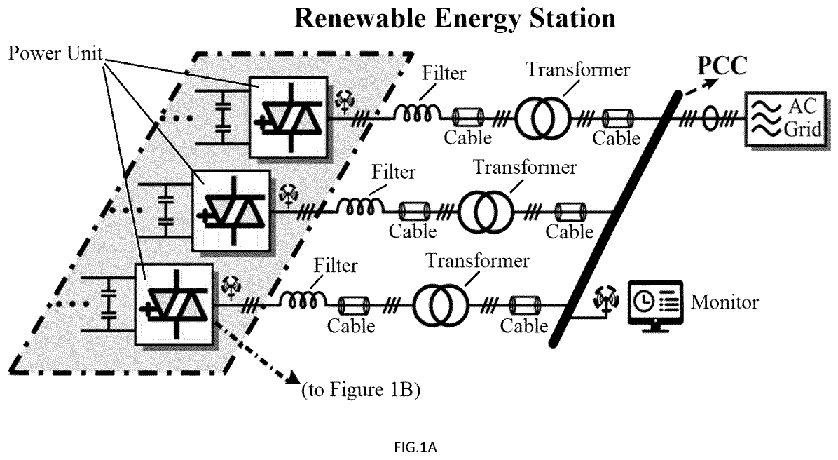

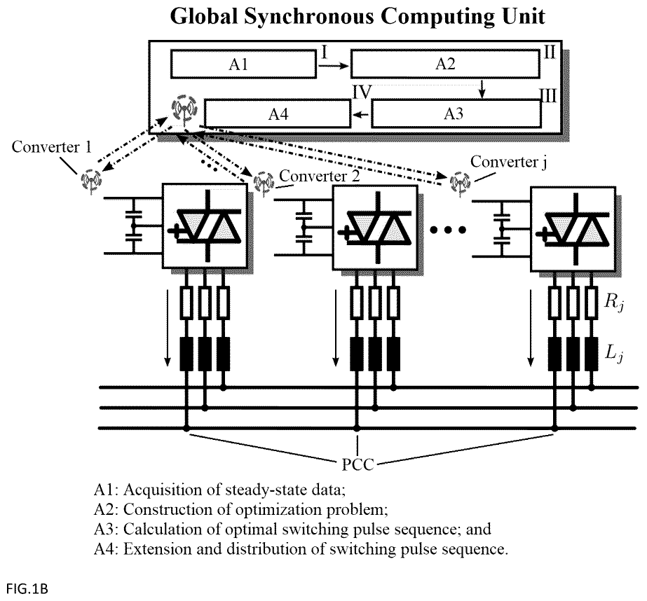

As shown in FIG. 1, the RES includes a plurality of power units (power converters). Each power unit is sequentially connected via cables to a filter, a transformer, and then to a PCC. One end of the PCC is connected to an output terminal, and the other end thereof is connected to a monitor.

S2: constructing a coordinated power quality optimization modulation equation based on the steady-state operating information, and adding constraints to the coordinated power quality optimization modulation equation based on fundamental volt-second characteristics and timing, to obtain an optimization problem;

### (1) Analysis of the Harmonic Pulse Coupling Mechanism in Converters

The purpose of harmonic programmed modulation is to utilize a limited number of switchings to achieve the desired optimal harmonics. According to the Fourier series theory, any periodic signal satisfying the Dirichlet conditions can be expanded into a series of sinusoidal functions of different frequencies, namely:

$$F ( t ) = {\sum }_{n = 0}^{N} [ {a}_{n} cos ( \frac{2 π n t}{T} ) + {b}_{n} sin ( \frac{2 π n t}{T} ) ] ;$$

wherein, T represents a fundamental period; n represents a harmonic order of decomposition; N represents a total harmonic order; aₙ and bₙ represent Fourier coefficients; t represents a time point; and F(t) represents a switching pulse function. Therefore, for the pulse sequence shown in FIG. 1, its harmonic composition can be determined as follows:

$${a}_{n} = \frac{2}{T} {\int }_{0}^{T} F ( t ) cos ( n ω t ) d t ,$$

$${b}_{n} = \frac{2}{T} {\int }_{0}^{T} F ( t ) sin ( n ω t ) dt ;$$

wherein, ω represents a fundamental angular frequency.

Since a quarter-wave symmetric waveform inherently possesses the ability to cancel DC components, even-order components, and cosine terms, the present invention employs this symmetry scheme. That is, the relationship between harmonic voltage and switching pulse coupling can be transformed as follows:

$${a}_{n} = 0 ,$$

$${b}_{n} = \frac{2 {V}_{d c}}{n π} {\sum }_{i = 1}^{d} {( - 1 )}^{i + 1} cos ( n {θ}_{i} ) ;$$

wherein, i represents a sequence of switching time points; d represents the number of switchings within a quarter period; V_{dc} represents a DC bus voltage; and θᵢ represents a switching pulse angle. Based on the formulas provided above, the relationship between the pulse sequence and voltage harmonics can be accurately established, providing a theoretical basis for subsequent harmonic optimization.

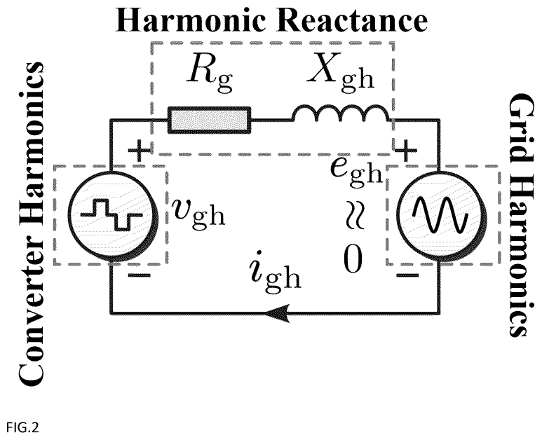

FIG. 2 shows a simplified frequency-domain model of the power converter, consisting of grid harmonics, converter harmonics, and harmonic reactance, where e_{gh} represents an h^{th} voltage harmonic contained in the grid; i_{gh} represents an h^{th} current harmonic generated by excitation; v_{gh} represents an h^{th} voltage harmonic generated by the converter; R_{g} represents equivalent parasitic resistance of the circuit; and X_{gh} represents equivalent impedance of the system at the h^{th} harmonic. According to the analysis, the harmonic current of the system under a specific harmonic voltage excitation can be expressed as follows:

$${i}_{n} = {\underbrace{\frac{{v}_{n}}{\sqrt{{( 2 π {nf}_{1} L )}^{2} + {R}^{2}}}}}_{R << 2π {nf}_{1} L} \approx \frac{{v}_{n}}{2 π {nf}_{1} L} ;$$

wherein, iₙ represents lumped harmonic current; vₙ represents harmonic voltage; n represents a harmonic order; f₁ represents a fundamental frequency of the system; L represents inductive reactance of a line and filter; and L represents parasitic resistance of the line and filter.

The total harmonic distortion of the system current is defined as follows:

$${I}_{T H D} = \frac{{i}_{h}}{{i}_{1}} = \frac{\sqrt{{i}_{2}^{2} + {i}_{3}^{2} + … + {i}_{n}^{2}}}{{i}_{1}} ;$$

wherein, I_{THD} represents the total harmonic distortion of the current; iₕ represents the lumped harmonic current; and i₁ represents fundamental current.

Since, under certain operating conditions, the expected fundamental current amplitude of the system is fixed, the optimization of power quality can be simplified as follows:

$$Min {I}_{T H D} ⇒ {\sum }_{n = 5}^{L} {i}_{n}^{2} ⇒ {\sum }_{n = 5}^{L} {( \frac{{v}_{n}}{2 π {nf}_{1} L} )}^{2} ⇒ {\sum }_{n = 5}^{L} {( \frac{{v}_{n}}{n} )}^{2} .$$

However, the above optimization is limited to individual converter systems and has a limited effect on improving the overall performance of the RES. To fully utilize the additional degrees of freedom provided by the converter cluster within the station, the harmonic coupling relationships within the converter cluster are further derived.

### (2) Construction of the Coordinated Power Quality Optimization Modulation Equation

The impact of individual converters on the current injection at the PCC can be derived using Kirchhoff's Laws, namely:

$${i}_{a , j} = \frac{{v}_{a , j} - {v}_{no , j} - {e}_{a}}{{z}_{a , j}} ;$$

wherein, i_{a,j} represents phase current of the j^{th} sub-unit; v_{a,j} represents phase voltage of the j^{th} sub-unit; v_{no,j} represents common-mode voltage of the j^{th} sub-unit; z_{a,j} represents lumped impedance of the line and filter; and eₐ represents grid phase voltage.

For high-power converter scenarios, the inductive reactance characteristics of the filter and transmission line far exceed their resistance characteristics. Therefore, iₙ the modeling process, their electro physical characteristics can be replaced by inductive components. Thus, the impact of individual converters on the total current at the PCC can be expressed as follows:

$${i}_{a , n , j} = \frac{{A}_{n , j} ∠ {ϕ}_{j}}{{Z}_{n , j} ∠90°} , n ∈ 6 k \pm 1 , k ∈ {N}^{+} ;$$

wherein, A_{n,j} represents a lumped voltage amplitude of the j^{th} sub-unit; φⱼ represents a lumped voltage phase of the j^{th} sub-unit; Z_{n,j} represents lumped impedance of the j^{th} sub-unit at an n^{th} harmonic; α represents a phase label; j represents the j^{th} sub-unit; and k represents any positive integer.

Therefore, the current at the PCC can be expressed as follows:

$${i}_{a , n , p c c} = {\sum }_{j = 1}^{{N}_{j}} \frac{{K}_{j}}{n} {A}_{n , j} ∠ ( {ϕ}_{j} - 90 ° ) , n ∈ 6 k \pm 1 ;$$

wherein, Nⱼ represents the total number of sub-units; φⱼ represents the lumped voltage phase of the j^{th} sub-unit; n represents the harmonic order; and Kⱼ represents a converter coefficient, namely

$${K}_{j} = \frac{n}{{z}_{n , j}} .$$

Consequently, the overall power quality optimization for the RES can be expressed as follows:

$$Min {I}_{T H D} ⇒ {\sum }_{n = 5}^{L} {i}_{n}^{2} ⇒ {\sum }_{n = 5}^{L} {( {\sum }_{j = 1}^{{N}_{j}} {i}_{n , j} )}^{2} ⇒ {\sum }_{n = 5}^{L} {( {\sum }_{j = 1}^{{N}_{j}} \frac{{K}_{j}}{n} {v}_{n , j} )}^{2} ;$$

wherein, i_{n,j} represents n^{th} harmonic current of the j^{th} sub-unit; and v_{n,j} represents n^{th} harmonic voltage of the j^{th} sub-unit.

Simultaneously, to satisfy the fundamental volt-second characteristics and timing required for obtaining the optimal pulse sequence, that is to say, to ensure the converter pulse width sequence derived from the solution has the desired fundamental amplitude and achievable timing constraints, relevant restrictions (constraints) are added to a final optimization problem, as shown below:

$$Minimize EF = {\underbrace{{\sum }_{n = 5}^{L} {( {\sum }_{j = 1}^{{N}_{j}} \frac{{K}_{j} {v}_{n , j}}{n} )}^{2}}}_{PCC , curr .} + {\underbrace{{\sum }_{j = 1}^{{N}_{j}} {ℒ}_{i} {\sum }_{n = 5}^{L} {( \frac{{v}_{n , j}}{n} )}^{2}}}_{Unit , curr .} ;$$

$$Subject to \frac{2 {V}_{d c , 1}}{π} {\sum }_{i = 1}^{N} {( - 1 )}^{i + 1} cos ( {θ}_{i , 1} ) = {M}_{1 , 1} ;$$

$$… \frac{2 {V}_{d c , j}}{π} {\sum }_{i = 1}^{N} {( - 1 )}^{i + 1} cos ( {θ}_{i , j} ) = {M}_{1 , j} ;$$

$$0 < {θ}_{1 , j} < {θ}_{2 , j} … < {θ}_{N , j} < \frac{π}{2} ;$$

wherein, EF represents a cost evaluation function; [symbol] ᵢ represents a considered upper harmonic limit; V_{dc,1} represents a first DC bus voltage; V_{dc,j} represents a j^{th} DC bus voltage; M_{1,1} represents a desired fundamental modulation index of a first sub-unit; M_{1,j} represents a desired fundamental modulation index of the j^{th} sub-unit; θ_{i,j} represents an i^{th} switching time point of the j^{th} sub-unit, and θ_{N,j} represents an N^{th} switching time point of the j^{th} sub-unit.

S3: solving the optimization problem using an optimization solver to obtain an optimal switching pulse sequence for the converter cluster at an ideal operating point.

In the present example, to solve for the ideal operating point: based on the constructed optimization problem, the overall switching pulse sequence for the converter cluster at the ideal operating point can be obtained using an optimization solver, such as a commercial QP solver. The ideal operating point refers to the calculated ideal operating state of the system based on the steady-state operating information collected by the system. However, it should be noted that even under steady-state operating conditions, the modulation index of the converter system is not fixed. Therefore, it is necessary to extend the modulation index range corresponding to the solved pulse sequence.

S4: extending a modulation range corresponding to the obtained optimal switching pulse sequence by using a gradient descent algorithm, calculating a switching pulse sequence modulated near an ideal operating point of the converter cluster and distributing the switching pulse sequence to each converter in the converter cluster through a central control unit.

In the present example, since the system state is dynamically stable, it is insufficient to calculate only the optimal switching pulse sequence at the ideal operating point; extension is required, achieving optimal pulse width extension and information distribution: by further changing the desired fundamental modulation indexes M_{1,j} of the sub-units, the gradient descent algorithm is used to solve the final optimization problem extensionally, thereby achieving the extended calculation of the switching pulse sequence for modulations adjacent to the ideal operating point of the converter cluster. Finally, the switching pulse data is distributed to each converter in the RES through information interaction.

Specifically, by reconstructing the modulation index M_{1,j} of each converter within a set modulation index range (preferably, within a variation range of ±0.3 modulation index), using the ideal operating point as the initial calculation point, and solving the final optimization problem via the gradient descent method, the switching pulse sequence for the pulse width modulation of the converter cluster under operating conditions near the ideal operating point can be obtained. This switching pulse sequence is then uniformly distributed by the central computing unit to each converter for updating their respective switching pulse sequences.

Each converter in the RES receives the extended switching pulse sequence issued by the central control unit, and regulates an output voltage of the converter to rise or fall according to a position and width value of a switching pulse for effective control of the converter within the extended switching pulse sequence, enabling the converter cluster composed of each converter in the RES to operate around the ideal operating point, thereby achieving harmonic optimization at a PCC of the RES.

Wherein, in the present example, the switching pulse for effective control of the converter used for regulating the output voltage of the converter to rise or fall is confirmed by: comparing an actual output voltage with an expected output voltage of the ideal operating point of the each converter.

In S3, the optimal switching pulse sequence is calculated only for individual operating conditions, while in S4, it is further extended to more operating conditions, thereby calculating the optimal switching pulse sequences for other operating conditions. According to the aforementioned method, in the tested four-converter power unit of the present example, the total harmonic distortion of the injected current was reduced by approximately 97% compared to the conventional carrier-based method.

Therefore, whereas conventional methods analyze the harmonic energy efficiency corresponding to switching pulses from the perspective of individual converters, the method proposed by the present invention analyzes from the perspective of the entire station, comprehensively utilizing the selection of each converter's switching pulse combination, thereby achieving harmonic cancellation within the cluster, improving power quality, and reducing overall harmonic injection. The additional degrees of freedom refer to the extra coordinated control degrees of freedom brought by cluster coordination.

### Example II

The present example provides a generalized synchronous optimal pulse width modulation system for a RES, including:
a data acquisition module, configured to: acquire steady-state operating information of a converter cluster in the RES;
a problem construction module, configured to: construct a coordinated power quality optimization modulation equation based on the steady-state operating information, and add constraints to the coordinated power quality optimization modulation equation based on fundamental volt-second characteristics and timing, to obtain an optimization problem;
a problem solving module, configured to: solve the optimization problem using an optimization solver to obtain an optimal switching pulse sequence for the converter cluster at an ideal operating point; and
a sequence extension module, configured to: extend a modulation range corresponding to the obtained optimal switching pulse sequence by using a gradient descent algorithm, calculate a switching pulse sequence modulated near an ideal operating point of the converter cluster, and distribute the switching pulse sequence to each converter in the converter cluster through a central control unit; and
receiving, by the each converter in the RES, the switching pulse sequence after the extension issued by the central control unit, confirm an effective control pulse for controlling output voltage of the each converter to rise or fall by comparing an actual output voltage with an expected output voltage of the ideal operating point of the each converter, and regulating the output voltage of the each converter to rise or fall according to a time sequence position and a width value of the effective control pulse in the switching pulse sequence after the extension, so that the converter cluster formed by the each converter in the RES works around the ideal operating point, thereby realizing harmonic optimization at a PCC of the RES.

### Example III

The present example aims to provide a computing device, including a memory, a processor, and a computer program stored on the memory and executable on the processor, where the processor, when executing the computer program, implements the steps of the method provided in Example I.

### Example IV

The present example aims to provide a computer-readable storage medium having a computer program stored thereon, where the computer program, when executed by a processor, implements the steps of the method provided in Example I.

The various steps involved in the devices of the above Examples III and IV correspond to Method Example I. For specific implementation manners, reference may be made to the relevant descriptions of Example I. The term “computer-readable storage medium” should be understood to include a single medium or multiple media containing one or more instruction sets; it should also be understood to include any medium that is capable of storing, encoding, or carrying instruction sets for execution by a processor and that causes the processor to perform any of the methods in the present invention.

Those skilled in the art should understand that the various modules or steps of the present invention described above can be implemented by a general-purpose computer device. Optionally, they can be implemented by program code executable by a computing device. Consequently, they can be stored in a storage device for execution by the computing device, or they can be made into individual integrated circuit modules, or multiple modules or steps therein can be made into a single integrated circuit module for implementation. The present invention is not limited to any specific combination of hardware and software.

The foregoing is only illustrative of the exemplary embodiments of the present invention and is not intended to limit the present invention. For those skilled in the art, the present invention may have various modifications and changes. Any modifications, equivalent replacements, improvements, and the like made within the spirit and principle of the present invention shall fall within the scope of protection of the present invention.

Although the embodiments of the present invention have been described above in conjunction with the accompanying drawings, they are not intended to limit the scope of protection of the present invention. Those skilled in the art should understand that, based on the technical solutions of the present invention, various modifications or variations made by those skilled in the art without making creative efforts still fall within the scope of protection of the present invention.

1. A method of generalized synchronous optimal pulse width modulation (PWM) for a renewable energy station (RES), comprising:
acquiring steady-state operating information of a converter cluster in the renewable energy station;
constructing a coordinated power quality optimization modulation equation based on the steady-state operating information, and adding constraints to the coordinated power quality optimization modulation equation based on fundamental volt-second characteristics and timing, to obtain an optimization problem;
wherein the coordinated power quality optimization modulation equation is expressed as follows:
$$Min {I}_{T H D} ⇒ {\sum }_{n = 5}^{L} {i}_{n}^{2} ⇒ {\sum }_{n = 5}^{L} {( {\sum }_{j = 1}^{{N}_{j}} {i}_{n , j} )}^{2} ⇒ {\sum }_{n = 5}^{L} {( {\sum }_{j = 1}^{{N}_{j}} \frac{{K}_{j}}{n} {v}_{n , j} )}^{2} ;$$
wherein, I_{THD} represents total harmonic distortion of current; L represents inductive reactance of a line and filter; n represents a harmonic order; iₙ represents lumped harmonic current; Nⱼ represents the total number of sub-units; i_{n,j} represents n^{th} harmonic current of a j^{th} sub-unit; Kⱼ represents a converter coefficient; and v_{n,j} represents n^{th} harmonic voltage of the j^{th} sub-unit;
wherein, the optimization problem is expressed as follows:
$$Minimize EF = {\underbrace{{\sum }_{n = 5}^{L} {( {\sum }_{j = 1}^{{N}_{j}} \frac{{K}_{j} {v}_{n , j}}{n} )}^{2}}}_{PCC , curr .} + {\underbrace{{\sum }_{j = 1}^{{N}_{j}} {ℒ}_{i} {\sum }_{n = 5}^{L} {( \frac{{v}_{n , j}}{n} )}^{2}}}_{Unit , curr .} ;$$
$$Subject to \frac{2 {V}_{d c , 1}}{π} {\sum }_{i = 1}^{N} {( - 1 )}^{i + 1} cos ( {θ}_{i , 1} ) = {M}_{1 , 1} ;$$
$$… \frac{2 {V}_{d c , j}}{π} {\sum }_{i = 1}^{N} {( - 1 )}^{i + 1} cos ( {θ}_{i , j} ) = {M}_{1 , j} ;$$
$$0 < {θ}_{1 , j} < {θ}_{2 , j} … < {θ}_{N , j} < \frac{π}{2} ;$$
wherein, EF represents a cost evaluation function; L represents the inductive reactance of the line and filter; n represents the harmonic order; Nⱼ represents the total number of sub-units; Kⱼ represents the converter coefficient; v_{n,j} represents the n^{th} harmonic voltage of the j^{th} sub-unit; [symbol] ᵢ represents a considered upper harmonic limit; V_{dc,1} represents a first DC bus voltage; V_{dc,j} represents a j^{th} DC bus voltage; M_{1,1} represents a desired fundamental modulation index of a first sub-unit; M_{1,j} represents a desired fundamental modulation index of the j^{th} sub-unit; θ_{i,j} represents an i^{th} switching time point of the j^{th} sub-unit; and θ_{N,j} represents an N^{th} switching time point of the j^{th} sub-unit;
solving the optimization problem using an optimization solver to obtain an optimal switching pulse sequence for the converter cluster at an ideal operating point; and
solving the optimization problem using a gradient descent algorithm to obtain a pulse width modulation lookup table for the converter cluster, extended over a set modulation index range from the ideal operating point, and distributing the same to each converter.

2. The generalized synchronous optimal PWM method for the RES of claim 1, wherein the steady-state operating information comprises modulation index, phase, and circuit parameters.

3. The generalized synchronous optimal PWM method for the RES of claim 1, wherein the optimization solver employs a quadratic programming solver.

4. The generalized synchronous optimal PWM method for the RES of claim 1, wherein the step of solving the optimization problem using the gradient descent algorithm specifically comprises: extending the solution of the optimization problem using the gradient descent algorithm by changing desired fundamental modulation indexes of the sub-units.

5. The generalized synchronous optimal PWM method for the RES of claim 1, wherein the pulse width modulation lookup table for the converter cluster is distributed to each converter through information interaction.

6. A generalized synchronous optimal pulse width modulation (PWM) system for a renewable energy station (RES), comprising:
a data acquisition module, configured to: acquire steady-state operating information of a converter cluster in the RES;
a problem construction module, configured to: construct a coordinated power quality optimization modulation equation based on the steady-state operating information, and add constraints to the coordinated power quality optimization modulation equation based on fundamental volt-second characteristics and timing, to obtain an optimization problem;
wherein, the coordinated power quality optimization modulation equation is expressed as follows:
$$Min {I}_{T H D} ⇒ {\sum }_{n = 5}^{L} {i}_{n}^{2} ⇒ {\sum }_{n = 5}^{L} {( {\sum }_{j = 1}^{{N}_{j}} {i}_{n , j} )}^{2} ⇒ {\sum }_{n = 5}^{L} {( {\sum }_{j = 1}^{{N}_{j}} \frac{{K}_{j}}{n} {v}_{n , j} )}^{2} ;$$
wherein, I_{THD} represents total harmonic distortion of current; L represents inductive reactance of a line and filter; n represents a harmonic order; iₙ represents lumped harmonic current; Nᵢ represents the total number of sub-units; i_{n,j} represents n^{th} harmonic current of a j^{th} sub-unit; Kⱼ represents a converter coefficient; and v_{n,j} represents n^{th} harmonic voltage of the j^{th} sub-unit;
wherein, the optimization problem is expressed as follows:
wherein, relevant restrictions (constraints) are added to a final optimization problem, as shown below:
$$Minimize EF = {\underbrace{{\sum }_{n = 5}^{L} {( {\sum }_{j = 1}^{{N}_{j}} \frac{{K}_{j} {v}_{n , j}}{n} )}^{2}}}_{PCC , curr .} + {\underbrace{{\sum }_{j = 1}^{{N}_{j}} {ℒ}_{i} {\sum }_{n = 5}^{L} {( \frac{{v}_{n , j}}{n} )}^{2}}}_{Unit , curr .} ;$$
$$Subject to \frac{2 {V}_{d c , 1}}{π} {\sum }_{i = 1}^{N} {( - 1 )}^{i + 1} cos ( {θ}_{i , 1} ) = {M}_{1 , 1} ;$$
$$… \frac{2 {V}_{d c , j}}{π} {\sum }_{i = 1}^{N} {( - 1 )}^{i + 1} cos ( {θ}_{i , j} ) = {M}_{1 , j} ;$$
$$0 < {θ}_{1 , j} < {θ}_{2 , j} … < {θ}_{N , j} < \frac{π}{2} ;$$
wherein, EF represents a cost evaluation function; L represents the inductive reactance of the line and filter; n represents the harmonic order; Nⱼ represents the total number of sub-units; Kⱼ represents the converter coefficient; v_{n,j} represents the n^{th} harmonic voltage of the j^{th} sub-unit; [symbol] ᵢ represents a considered upper harmonic limit; V_{dc,1} represents a first DC bus voltage; V_{dc,j} represents a j^{th} DC bus voltage; M_{1,1} represents a desired fundamental modulation index of a first sub-unit; M₁, represents a desired fundamental modulation index of the j^{th} sub-unit; θ_{i,j} represents an i^{th} switching time point of the j^{th} sub-unit; and θ_{N,j} represents an N^{th} switching time point of the j^{th} sub-unit;
a problem solving module, configured to: solve the optimization problem using an optimization solver to obtain an optimal switching pulse sequence for the converter cluster at an ideal operating point; and
a sequence extension module, configured to: solve the optimization problem using a gradient descent algorithm to obtain a pulse width modulation lookup table for the converter cluster, extended over a set modulation index range from the ideal operating point, and distribute the same to each converter.

7. A computer-readable storage medium, having a computer program stored thereon, wherein the computer program, when executed by a processor, implements the steps of the generalized synchronous optimal pulse width modulation method for the renewable energy station of claim 1.

8. A computer device, comprising a memory, a processor, and a computer program stored in the memory and executable on the processor, wherein the processor, when executing the computer program, implements the steps of the generalized synchronous optimal pulse width modulation method for the renewable energy station of claim 1.
